(19) United States
(12) Patent Application Publication
(10) Pub. No.: US 2006/0082459 A1
(43) Pub. Date: Apr. 20, 2006

(54) Child guard

(76) Inventor: Adolph D. Alvarez, San Antonio, TX (US)

Correspondence Address: Adolph D. Alvarez, PO Box 691153, San Antonio, TX, 78259, US

(21) Appl. No.: 10/911,131

(22) Filed: Oct. 18, 2004

(51) Int. Cl. G08B 23/00

(52) U.S. Cl. 340/573.1

(57) ABSTRACT

Child Guard is a unique child protective system. Child guard has the ability through a motion detector to sense whether a child has been left in a hot vehicle to suffer an agonizing death. The motion detector is in operation at all times once the system has been armed when the ignition is turned off. When the motion detector senses a child in the vehicle it sends a signal to a siren and the first thermostat set at 78 degrees. The first thermostat sends a signal to the vehicle magnetic relay and the start module to start the engine and the air conditioner. If the motor or the air conditioner should become inoperative for any reason the second thermostat set at 83 degrees sends a signal to the magnetic relay and the window module causing the windows to open. The window switches are wired on the down switchs only preventing a child from closeing the windows and injure it self. The child protective system is disarmed when the ignition is turned on.

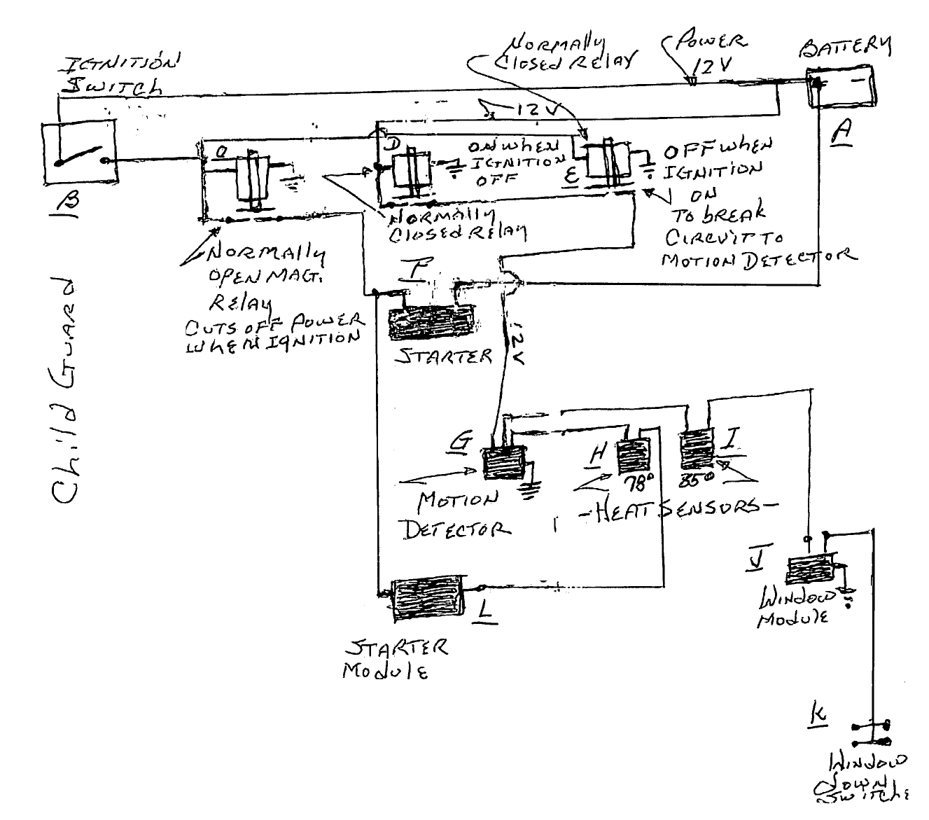

Child Guard Specifications
A. Power supply—Automobile battery
B. Automobile ignition switch Normally open magnetic relay (C) cuts off power when the ignition is cut off.
C. Normally closed magnetic relay (D) cuts off the power to the entire system.
D. Magnetic relay (E) is off when the ignition is on to break the circuit to the motion detector.
E. Automobile starter (F) is activated either by the ignition switch or by (L) starter module.
F. Motion detector (G) is activated at all times once the ignition switch is turned off activating the 80 degree heat sensor (H) (thermostat) activating the starter module (L) to start the engine and air conditioner.
G. The 90 degree heat sensor (thermostat) (I) activates the window module (J) lowering the windows (K) in case the motor or air conditioner should fail.
H. All four window down switches (K) are activated by the (J) window module. The windows cannot be raised once the system is in the down window mode.

1. I Adolph D. Alvarez do hereby claim the utility invention titled Child Guard. This utility invention is for the purpose of preventing a child or children from dying in a hot vehicle from beat prostration or suffocation and protect a child from strangling itself with the power windows.
